(19) United States
(12) Patent Application Publication
(10) Pub. No.: US 2009/0258300 A1
(43) Pub. Date: Oct. 15, 2009

(54) Ethylene/Vinyl Alcohol-Derived Copolymer Fiber

(75) Inventors: Takamasa Moriyama, Osaka (JP); Kaoru Inoue, Osaka (JP)

Correspondence Address: HAMRE, SCHUMANN, MUELLER & LARSON, P.C., P.O. BOX 2902, MINNEAPOLIS, MN, 55402-0902, US

(73) Assignee: The Nippon Synthetic Chemical Industry Co., Ltd., Osaka-shi (JP)

(21) Appl. No.: 12/084,927

(22) PCT Filed: Nov. 14, 2006
(86) PCT No.: PCT/JP2006/322672

§ 371 Date: May 13, 2008

(30) Foreign Application Priority Data
Nov. 14, 2005 (JP) 2005-329114

(51) Int. Cl. D01F 6/50; C08F 210/02; C08F 118/04; C08K 3/38; C08K 3/32; C08L 23/06; C08L 29/04; D04H 1/00; H01M 2/16; D01F 8/10

(52) U.S. Cl. 429/249; 526/348.8; 526/319; 524/405; 524/417; 525/59; 525/57; 428/401; 442/327; 428/219; 428/373

(57) ABSTRACT

The invention provides a fiber which is excellent in electrolyte absorption and retentivity and oxidation resistance and is suitable for use as a separator for alkaline secondary batteries. The invention is an ethylene/vinyl alcohol-derived copolymer fiber comprising an ethylene/vinyl alcohol-derived copolymer (A) having the following structural unit (1):

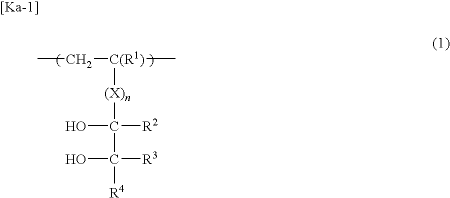

(wherein R¹ represents a hydrogen atom or an organic group; X represents a bonding chain other than ether bond; n represents 0 or 1; and R² to R⁴ each represent a hydrogen atom or an organic group).

### TECHNICAL FIELD

The present invention relates to a novel fiber containing an ethylene/vinyl alcohol-derived copolymer. More particularly, the invention relates to a fiber suitable for use as a material for a separator for secondary batteries employing an alkaline liquid as the electrolyte.

### BACKGROUND ART

Fibers formed from an ethylene/vinyl alcohol-derived copolymer (herein after abbreviated to EVOH) as a raw material have excellent hydrophilicity and moisture-absorbing/releasing properties unlike conventional synthetic fibers because the EVOH has hydroxyl groups therein. Fibers of this copolymer alone and composite fibers made of this copolymer and other thermoplastic resin(s) have been extensively used as materials for sportswear, etc.

Other various applications are being investigated. In particular, investigations are being made on the application of nonwoven fabrics made of such EVOH fibers and composite fibers to the separator of an alkaline secondary battery.

This separator is for separating the anode active material and cathode active material of a battery. In alkaline secondary batteries, nonwoven fabrics made of polyamide fibers or polyolefin fibers are generally used extensively.

However, the polyamide fibers have had a drawback that they are susceptible to oxidation and oxidatively deteriorate due to the oxygen gas generating during charge. On the other hand, the polyolefin fibers have had the following problems. Polyolefin fibers have poor hydrophilicity and hence necessitate a hydrophilizing treatment such as, e.g., sulfo group introduction, leasing to an increase in cost. In addition, the hydrophilicity does not last for long. Furthermore, the polyolefin fibers which have undergone the hydrophilizing treatment are apt to deteriorate.

In order to overcome those problems, fibers containing an EVOH and battery separators employing a nonwoven fabric thereof have been investigated. Because of its hydrophilicity, an EVOH can be expected to enhance electrolyte absorption/retentivity. For example, a fiber for separators which is made of an EVOH having a specific degree of saponification and a specific ethylene content (see, for example, patent document 1) and a fiber for separators which is made of a mixture of an EVOH having a specific ethylene content and a polyamide (see, for example, patent document 2) have been proposed.

In recent years, however, alkaline secondary batteries have come to be increasingly required to have a smaller size and a higher output. With this trend, separators also have come to be required to have a higher degree of properties concerning electrolyte absorption/retentivity and oxidation resistance. The present inventor hence made close investigations on the fibers for battery separators described in those patent documents. As a result, it was found that the properties of those fibers are still insufficient for the current high degree of requirements.

### Patent Document 1: JP-A-2002-227031

### Patent Document 2: JP-A-2002-242024

### DISCLOSURE OF THE INVENTION

### Problems that the Invention is to Solve

An object of the invention is to provide an EVOH fiber which is excellent in electrolyte absorption/retentivity and oxidation resistance and is suitable for use as a separator for alkaline secondary batteries.

### Means for Solving the Problems

The present inventor diligently made investigations under those circumstances. As a result, it has been found that the object of the invention is accomplished with an EVOH into which a functional group having a 1,2-glycol structure has been introduced as a side chain. The invention has been thus completed.

Namely, an essential point of the invention resides in a fiber comprising an ethylene/vinyl alcohol-derived copolymer (A) having the following structural unit (1) (EVOH (A)) as shown below, and is characterized in that an EVOH having the structural units is used as a fiber.

(1)

An ethylene/vinyl alcohol-derived copolymer fiber (EVOH fiber) comprising an ethylene/vinyl alcohol-derived copolymer (A) (EVOH (A)) having the following structural unit (1):

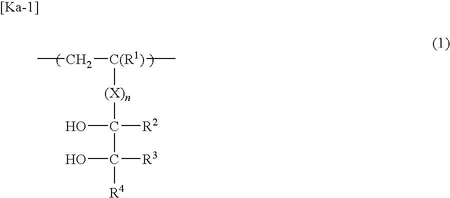

(wherein R¹ represents a hydrogen atom or an organic group; X represents a bonding chain other than ether bond; n represents 0 or 1; and R² to R⁴ each represent a hydrogen atom or an organic group).
(2)

The ethylene/vinyl alcohol-derived copolymer fiber as described under (1), wherein in the structural unit (1), R¹ is a hydrogen atom, n is 0, and R² to R⁴ each are a hydrogen atom.

(3)

The ethylene/vinyl alcohol-derived copolymer fiber as described under (1) or (2), wherein the content of structural unit (1) in the ethylene/vinyl alcohol-derived copolymer (A) is 0.1-30% by mole.

(4)

The ethylene/vinyl alcohol-derived copolymer fiber as described under any one of (1) to (3), wherein the ethylene/vinyl alcohol-derived copolymer (A) has an ethylene content of 10-60% by mole.

(5)

The ethylene/vinyl alcohol-derived copolymer fiber as described under any one of (1) to (4), wherein the ethylene/vinyl alcohol-derived copolymer (A) is one obtained by saponifying a copolymer of a 3,4-diacyloxy-1-butene, a vinyl ester monomer, and ethylene.

(6)

The ethylene/vinyl alcohol-derived copolymer fiber as described under any one of (1) to (5), wherein the ethylene/vinyl alcohol-derived copolymer (A) is a composition containing a boron compound.

(7)

The ethylene/vinyl alcohol-derived copolymer fiber as described under any one of (1) to (5), wherein the ethylene/vinyl alcohol-derived copolymer (A) is a composition containing a phosphoric acid compound.

(8)

The ethylene/vinyl alcohol-derived copolymer fiber as described under (7), wherein the phosphoric acid compound is a phosphoric acid salt.

(9)

An ethylene/vinyl alcohol-derived copolymer fiber, which is a composite fiber comprising an ethylene/vinyl alcohol-derived copolymer (A) having the following structural unit (1) and a thermoplastic resin (B) other than the (A):

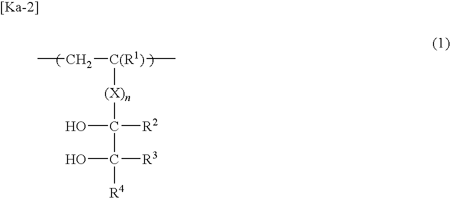

(wherein R¹ represents a hydrogen atom or an organic group; X represents a bonding chain other than ether bond; n represents 0 or 1; and R² to R⁴ each represent a hydrogen atom or an organic group).
(10)

The ethylene/vinyl alcohol-derived copolymer fiber as described under (9), wherein the composite fiber is a split type composite fiber.

(11)

The ethylene/vinyl alcohol-derived copolymer fiber as described under (9), wherein the composite fiber is a core/sheath type composite fiber.

(12)

The ethylene/vinyl alcohol-derived copolymer fiber as described under any one of (9) to (11), wherein the thermoplastic resin (B) is any of a polyester polymer, a polyamide polymer, and a polyolefin polymer.

(13)

The ethylene/vinyl alcohol-derived copolymer fiber as described under any one of (9) to (12), wherein the ratio in which the ethylene/vinyl alcohol-derived copolymer (A) and the thermoplastic resin (B) are combined is from 10/90 to 90/10.

(14)

The ethylene/vinyl alcohol-derived copolymer fiber as described under any one of (1) to (13), which has a fiber diameter of 0.1-100 deniers.

(15)

A nonwoven fabric comprising the ethylene/vinyl alcohol-derived copolymer fiber as described under any one of (1) to (14).

(16)

The nonwoven fabric as described under (15), which has a basis weight of 10-100 g/m².

(17)

A separator for batteries, comprising the nonwoven fabric as described under (15) or (16).

The following is presumed. In the invention, because the EVOH has those structural units, it has better hydrophilicity and better water retentivity than conventional EVOHs. Because those structural units are stable even under oxidizing conditions, the fiber, when used as a material for, e.g., a battery separator, stably brings about excellent electrolyte absorption and retentivity.

### ADVANTAGES OF THE INVENTION

The EVOH fiber of the invention is excellent in electrolyte absorption/retentivity and in oxidation resistance and is suitable for use as a fiber for separators for alkaline secondary batteries.

### BRIEF DESCRIPTION OF THE DRAWINGS

FIG. 1 is a ¹H-NMR chart for the unsaponified EVOH obtained in Polymerization Example 1.

FIG. 2 is a ¹H-NMR chart for the EVOH obtained in Polymerization Example 1.

### BEST MODE FOR CARRYING OUT THE INVENTION

The invention will be explained below in detail.

The following explanations on constituent elements are for embodiments (typical embodiments) of the invention, and the invention should not be construed as being limited to the contents of these.

The EVOH fiber of the invention is an EVOH fiber comprising an EVOH (A) containing the following structural unit (1), wherein R¹ represents a hydrogen atom or an organic group; X represents a bonding chain other than ether bond; n represents 0 or 1; and R² to R⁴ each represent a hydrogen atom or an organic group.

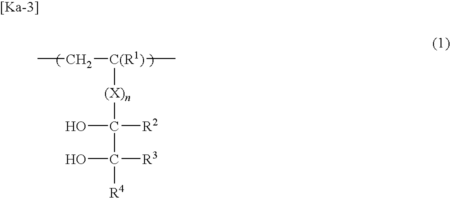

The composition of the EVOH (A) in the invention is not particularly limited.

The content of structural unit (1) in the EVOH (A) is generally 0.1-30% by mole, preferably 0.2-20% by mole, especially preferably 0.3-10% by mole, most preferably 1-5% by mole. In case where the content thereof is too low, the effects of the invention are not sufficiently produced. Conversely, too high contents thereof tend to result in a decrease in oxidation resistance.

The content thereof can be regulated to such a value by blending at least two EVOHs (A) differing in content. At least one of these may be an EVOH containing no structural unit (1).

With respect to an EVOH in which the combined 1,2-glycol content has been thus regulated, the combined 1,2-glycol content may be calculated in terms of weight-average value and the ethylene content thereof also may be calculated in terms of weight-average value. However, precise values of ethylene content and combined 1,2-glycol content can be calculated from the results of a ¹H-NMR examination.

The ethylene content of the EVOH (A) in the invention is generally 0.1-60% by mole, preferably 10-60% by mole, especially preferably 20-50% by mole. Too low contents thereof tend to result in a decrease in fiber strength. Conversely, too high contents thereof tend to result in a decrease in electrolyte absorption and retentivity.

The content of vinyl alcohol structural units is generally 40-90% by mole, preferably 50-80% by mole, especially preferably 60-70% by mole. Too low contents thereof tend to result in a decrease in hydrophilicity, while too high contents thereof result in a possibility that this copolymer might have reduced stability in a thermally molten state.

The remainder may be vinylacetoxy structural units derived from vinyl acetate.

The degree of saponification of the EVOH (A) is generally 90% by mole or higher, preferably 95% by mole or higher, especially preferably 99% by mole or higher. Too low degrees of saponification tend to result in a decrease in oxidation resistance.

When n in the bonding chain (X)ₙ in structural unit (1) is 1, then X may be any bonding chain other than ether bond, without particular limitations. Examples thereof include nonaromatic hydrocarbon chains such as alkylenes, alkenylenes, and alkynylenes and aromatic hydrocarbon chains such as phenylene and naphthylene (these hydrocarbon chains may have been substituted by, e.g., a halogen such as fluorine, chlorine, or bromine). Examples thereof further include —CO—, —COCO—, —CO(CH₂)ₘCO—, —CO(C₆H₄)CO—, —S—, —CS—, —SO—, —SO₂—, —NR—, —CONR—, —NRCO—, —CSNR—, —NRCS—, —NRNR—, —HPO₄—, —Si(OR)₂—, —OSi(OR)₂—, —OSi(OR)₂O—, —Ti(OR)₂—, —OTi(OR)₂—, —OTi(OR)₂O—, —Al(OR)—, —OAl (OR)—, and —OAl (OR)O— (Rs each independently are any desired substituent, and preferably are a hydrogen atom or an alkyl group; and m is a natural number). Of these, nonaromatic hydrocarbon chains are preferred from the standpoint of stability in a thermally molten state. Especially preferred are alkylenes. Preferred alkylenes are ones having a small number of carbon atoms because such alkylenes bring about satisfactory electrolyte retentivity. It is preferred to use an alkylene having up to 6 carbon atoms.

Incidentally, ether bonds are undesirable because they readily decompose during melt spinning to reduce the stability of the EVOH in a thermally molten state.

In the case where R¹ and R² to R⁴ in structural unit (1) are organic groups, these organic groups are not particularly limited. Preferred examples thereof include alkyl groups having 1-4 carbon atoms, such as methyl, ethyl, n-propyl, isopropyl, n-butyl, isobutyl, and tert-butyl. These organic groups may have substituents such as halogen groups, hydroxyl group, ester groups, carboxy group, and sulfo group according to need.

A most preferred structure of the EVOH (A) in the invention is one in which R¹ and R² to R⁴ in structural unit (1) each are a hydrogen atom and n in the bonding chain (X)ₙ is 0, i.e., (X)ₙ is a single bond. Namely, the preferred structure is one which contains a structural unit represented by the following structural formula (1a).

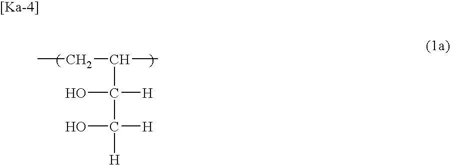

A most preferred composition of the copolymer in the invention is one which contains 1-5% by mole the structural units (1a) and has an ethylene content of 20-50% by mole and a vinyl alcohol structural unit content of 60-70% by mole, the remainder being vinylacetoxy structural units derived from vinyl acetate.

Processes for producing the EVOH (A) to be used in the invention are not particularly limited. However, in the case where the EVOH (A) having the most preferred structure, i.e., containing structural units (1a), is to be produced as an example, examples of production processes include: [1] a process in which 3,4-diol-1-butene, a 3,4-diacyloxy-1-butene, a 3-acyloxy-4-ol-1-butene, a 4-acyloxy-3-ol-1-butene, a 3,4-diacyloxy-2-methyl-1-butene, or the like is used as a comonomer and copolymerized with a vinyl ester monomer and ethylene to obtain a copolymer and this copolymer is then saponified; [2] a process in which vinylethylene carbonate or the like is used as a comonomer and copolymerized with a vinyl ester monomer and ethylene to obtain a copolymer and this copolymer is then saponified and decarboxylated; and [3] a process in which a 2,2-dialkyl-4-vinyl-1,3-dioxolane or the like is used as a comonomer and copolymerized with a vinyl ester monomer and ethylene to obtain a copolymer and this copolymer is then saponified and deacetalized.

Of these processes, the process in which a 3,4-diacyloxy-1-butene, a vinyl ester monomer, and ethylene are copolymerized and the copolymer obtained is saponified is preferred because these monomers have excellent copolymerizability. It is further preferred to use 3,4-diacetoxy-1-butene as the 3,4-diacyloxy-1-butene. A mixture of such monomers may also be used.

3,4-Diacetoxy-1-butane, 1,4-diacetoxy-1-butene, 1,4-diacetoxy-1-butane, or the like may be contained as a small amount of an impurity.

The process for copolymerization in which 3,4-diacetoxy-1-butene is used as a comonomer is explained below. However, usable processes should not be construed as being limited thereto.

Incidentally, the 3,4-diol-1-butene is represented by the following formula (2), 3,4-diacyloxy-1-butene by the following formula (3), 3-acyloxy-4-ol-1-butene by the following formula (4), and 4-acyloxy-3-ol-1-butene by the following formula (5).

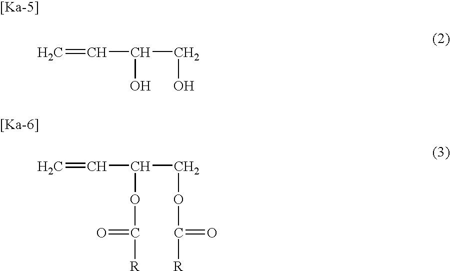

(In formula (3), R is an alkyl group, preferably methyl.)

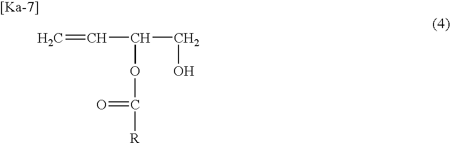

(In formula (4), R is an alkyl group, preferably methyl.)

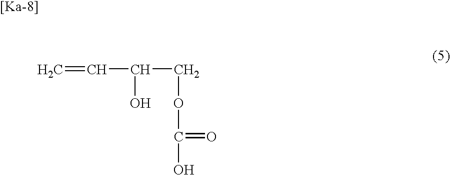

(In formula (5), R is an alkyl group, preferably methyl.)

The compound represented by formula (2) is available from Eastman Chemical Co. With respect to the compound represented by formula (3), one for industrial production and one of a reagent grade are available on the market as products of Eastman Chemical Co. and Acros Organics, respectively. It is also possible to utilize the 3,4-diacetoxy-1-butene obtained as a by-product in a 1,4-butanediol production step.

Examples of the vinyl ester monomer include vinyl formate, vinyl acetate, vinyl propionate, vinyl valerate, vinyl butyrate, vinyl isobutyrate, vinyl pivalate, vinyl caprate, vinyl laurate, vinyl stearate, vinyl benzoate, and Vinyl Versatate. Of these, vinyl acetate is preferred from the standpoint of profitability.

For copolymerizing a 3,4-diacyloxy-1-butene or the like with a vinyl ester monomer and ethylene monomer, a known method such as, e.g., bulk polymerization, solution polymerization, suspension polymerization, dispersion polymerization, or emulsion polymerization can be employed without particular limitations. In general, however, solution polymerization is conducted.

Methods of charging the monomer ingredients in the copolymerization are not particularly limited, and any desired method may be employed, such as, e.g., en bloc charging, portion-wise charging, or continuous charging.

The proportion of the 3,4-diacyloxy-1-butene or the like to be copolymerized is not particularly limited. However, the proportion thereof may be determined according to the amount of the structural unit (1) to be incorporated.

The ethylene content of the copolymer can be regulated by means of ethylene pressure during the polymerization. The pressure of ethylene is usually selected from the range of 25-80 kg/cm², although it depends on the target ethylene content and cannot be fixed unconditionally.

Examples of solvents usable for the copolymerization include saturated alcohols having 1-4 carbon atoms, such as methanol, ethanol, propanol, and butanol, and ketones such as acetone and methyl ethyl ketone. Methanol is suitable for industrial use.

The amount of the solvent to be used may be suitably selected according to the target degree of polymerization of the copolymer while taking account of the chain transfer constant of the solvent. For example, in the case where the solvent is methanol, a solvent amount may be selected from the S (solvent)/M (monomers) ratio range of about 0.01-10 (weight ratio), preferably 0.05-7 (weight ratio).

A polymerization catalyst may be used for the copolymerization. Examples of the polymerization catalyst include known radical polymerization catalysts such as azobisisobutyronitrile, acetyl peroxide, benzoyl peroxide, and lauryl peroxide and low-temperature-active radical polymerization catalysts such as peroxyesters, e.g., t-butyl peroxyneodecanoate, t-butyl peroxypivalate, α,α′-bis(neodecanoylperoxy)diisopropylbenzene, cumyl peroxyneodecanoate, 1,1,3,3-tetramethylbutyl peroxyneodecanoate, 1-cyclohexyl-1-methylethyl peroxyneodecanoate, t-hexyl peroxyneodecanoate, and t-hexyl peroxypivalate, peroxydicarbonates, e.g., di-n-propyl peroxydicarbonate, diisopropyl peroxydicarbonate], di-sec-butyl peroxydicarbonate, bis(4-t-butylcyclohexyl)peroxydicarbonate, di-2-ethoxyethyl peroxydicarbonate, di(2-ethylhexyl)peroxydicarbonate, dimethoxybutyl peroxydicarbonate, and di(3-methyl-3-methoxybutyl peroxy)dicarbonate, and diacyl peroxides, e.g., 3,3,5-trimethylhexanoyl peroxide, diisobutyryl peroxide, and lauroyl peroxide.

The amount of the catalyst to be used varies depending on the kind of the catalyst, and cannot be unconditionally fixed. However, the amount thereof may be selected at will according to polymerization rate. For example, in the case where azobisisobutyronitrile or acetyl peroxide is used, the amount thereof is preferably 10-2,000 ppm, especially preferably 50-1,000 ppm, of the vinyl ester monomer.

The reaction temperature for the copolymerization reaction varies depending on the solvent used and pressure. It is, however, preferred to select a reaction temperature in the range of about from 40° C. to the boil ing point.

In the invention, it is preferred to cause a hydroxylactone compound or hydroxycarboxylic acid to coexist with the catalyst from the standpoint of obtaining an EVOH (A) having a satisfactory color tone (close to colorlessness) The hydroxylactone compound is not particularly limited so long as it is a compound having a lactone ring and a hydroxyl group in the molecule. Examples thereof include L-ascorbic acid, erythorbic acid, and glucono-δ-lactone. It is preferred to use L-ascorbic acid or erythorbic acid. Examples of the hydroxycarboxylic acid include glycolic acid, lactic acid, glyceric acid, malic acid, tartaric acid, citric acid, and salicyclic acid. It is preferred to use citric acid.

The amount of the hydroxylactone compound or hydroxycarboxylic acid to be used is not particularly limited. However, the amount thereof is generally 0.0001-0.1 part by weight, preferably 0.0005-0.05 parts by weight, especially preferably 0.001-0.03 parts by weight, per 100 parts by weight of the vinyl acetate. Too small use amounts thereof are undesirable because there are cases where the effect of the addition thereof is not obtained. Conversely, too large amounts thereof are undesirable because the result is inhibition of the polymerization of the vinyl acetate.

Methods for introducing that compound into the polymerization system are not particularly limited. Usually, the compound is introduced into the polymerization reaction system as a dilution with a solvent, such as a lower aliphatic alcohol, aliphatic ester which may be vinyl acetate, or water, or with a mixed solvent composed of such solvents.

When a copolymer containing structural units of general formula (1) and consisting substantially of ethylene and vinyl acetate is produced in the invention, a copolymerizable ethylenically unsaturated monomer may be copolymerized in a small amount during the copolymerization according to need so long as this does not lessen the effects of the invention.

The copolymer obtained is subsequently saponified. In this saponification, the copolymer obtained above is dissolved in an alcohol or hydrous alcohol and saponified in this state using an alkali catalyst or acid catalyst. Examples of the alcohol include saturated alcohols having 1-4 carbon atoms, such as methanol, ethanol, propanol, and tert-butanol. However, methanol is especially preferred. The concentration of the copolymer in the alcohol may be suitably selected according to the viscosity of the system. In general, however, it is selected from the range of 10-60% by weight.

Examples of the catalyst to be used for the saponification include alkali catalysts such as alkali metal hydroxides or alcoholates, e.g., sodium hydroxide, potassium hydroxide, sodium methylate, sodium ethylate, potassium methylate, and lithium methylate, and acid catalysts such as sulfuric acid, hydrochloric acid, nitric acid, methanesulfonic acid, zeolites, and cation-exchange resins.

The amount of such a saponification catalyst to be used may be selected according to saponification method, the target degree of saponification, etc. However, in the case of using an alkali catalyst, the suitable amount thereof is generally 0.001-0.1 equivalent, preferably 0.005-0.05 equivalents, to the sum of the vinyl ester monomer and the 3,4-diacyloxy-1-butene, etc.

With respect to methods for the saponification, any of batch saponification, continuous saponification on a belt, and column type continuous saponification can be used according to the target degree of saponification, etc. Preferably, column type saponification at a given pressure is used, for example, because the amount of the alkali catalyst to be used for the saponification can be reduced and the saponification reaction is apt to proceed highly efficiently. The pressure during the saponification depends on the target ethylene content and cannot be unconditionally fixed. However, it may be selected from the range of 2-7 kg/cm². The temperature in this saponification may be selected from 80-150° C., preferably 100-130° C.

Various ingredients can be incorporated into the EVOH (A) of the invention thus obtained. For example, addition of an acid, such as acetic acid, phosphoric acid, or boric acid, or a salt thereof with a metal such as an alkali metal, alkaline earth metal, or transition metal to the EVOH (A) is preferred because this can improve the thermal stability of the EVOH (A).

The amount of the acetic acid to be added to the EVOH (A) is generally 0.001-1 part by weight, preferably 0.005-0.2 parts by weight, especially preferably 0.010-0.1 part by weight, per 100 parts by weight of the EVOH (A). When the addition amount thereof is too small, there are cases where the effect of incorporation of the acid is not sufficiently obtained. Conversely, too large amounts thereof tend to make it difficult to obtain uniform fibers.

Examples of the acetic acid salt to be added to the EVOH (A) include alkali metal salts such as sodium acetate and potassium acetate, alkaline earth salts such as magnesium acetate, calcium acetate, and barium acetate, and transition metal salts such as zinc acetate and manganese acetate. The amount of the salt to be added is generally 0.0005-0.1 part by weight, preferably 0.001-0.05 parts by weight, especially preferably 0.002-0.03 parts by weight, in terms of metal amount per 100 parts by weight of the EVOH (A). When the addition amount thereof is too small, there are cases where the effect of incorporation of the salt is not sufficiently obtained. Conversely, too large amounts thereof tend to make it difficult to obtain uniform fibers.

Examples of the boron compound to be added to the EVOH (A) include boric acid and boric acid metal salts. Examples of the boric acid metal salts include lithium salts such as lithium metaborate, lithium tetraborate, and lithium pentaborate, sodium salts such as sodium metaborate, sodium diborate, sodium tetraborate, sodium pentaborate, sodium hexaborate, and sodium octaborate, potassium salts such as potassium metaborate, potassium tetraborate, potassium pentaborate, potassium hexaborate, and potassium octaborate, and such alkali metal salts; calcium salts such as calcium borate, magnesium salts such as magnesium orthoborate, magnesium diborate, magnesium metaborate, trimagnesium tetraborate, and pentamagnesium tetraborate, barium salts such as barium orthoborate, barium metaborate, barium diborate, and barium tetraborate, and alkaline earth metal salts of these; cobalt salts such as cobalt borate; manganese salts such as manganous borate, manganese metaborate, and manganese tetraborate; nickel salts such as nickel orthoborate, nickel diborate, nickel tetraborate, and nickel octaborate; copper salts such as cupric borate, copper metaborate, and copper tetraborate; boric acid silver salts such as silver metaborate and silver tetraborate; zinc salts such as zinc tetraborate and zinc metaborate; cadmium salts such as cadmium orthoborate and cadmium tetraborate; lead salts such as lead metaborate and lead hexaborate; bismuth salts such as bismuth borate; and complex salts such as aluminum potassium borate. Examples thereof further include ammonium salts such as ammonium metaborate, ammonium tetraborate, ammonium pentaborate, and ammonium octaborate; and borate minerals such as borax, cahnite, inyoite, kotoite, suanite, and szaibelyite.

The amount of the boron compound to be added is generally 0.001-1 part by weight, preferably 0.002-0.2 parts by weight, especially preferably 0.005-0.1 part by weight, in terms of boron amount per 100 parts by weight of the EVOH (A). Too small addition amounts thereof are undesirable because there are cases where the effect of incorporation of the compound is not sufficiently obtained. Conversely, too large amounts thereof are undesirable because it is difficult to obtain uniform fibers.

Examples of the phosphorus compound to be added to the EVOH (A) include phosphoric acid and phosphoric acid metal salts. Examples of the phosphoric acid metal salts include sodium salts such as sodium dihydrogen phosphate and disodium hydrogenphosphate, potassium salts such as potassium dihydrogen phosphate, dipotassium hydrogen phosphate, and tripotassium phosphate, and alkali metal salts or monovalent salts of these; and divalent salts such as calcium salts, e.g., calcium monohydrogen phosphate, calcium dihydrogen phosphate, and tricalcium phosphate, magnesium salts such as magnesium phosphate, magnesium hydrogen phosphate, and magnesium dihydrogen phosphate, and alkaline earth metal salts of these, zinc hydrogen phosphate, barium hydrogen phosphate, and manganese hydrogen phosphate. Preferred examples thereof include phosphoric acid, sodium dihydrogen phosphate, potassium dihydrogen phosphate, calcium dihydrogen phosphate, and magnesium dihydrogen phosphate. The amount of the phosphoric acid compound to be added is generally 0.0005-0.1 part by weight, preferably 0.001-0.05 parts by weight, especially preferably 0.002-0.03 parts by weight, in terms of phosphoric acid radical amount per 100 parts by weight of the EVOH (A). When the addition amount thereof is too small, there are cases where the effect of incorporation of the compound is not sufficiently obtained. Conversely, too large amounts thereof tend to make it difficult to obtain uniform fibers.

Methods for adding an acid or metal salt thereof to the EVOH (A) are not particularly limited. Examples thereof include: (a) a method in which a porous EVOH (A) precipitate having a water content of 20-80% by weight is brought into contact with an aqueous solution of an acid or metal salt thereof to incorporate the acid or metal salt thereof and is then dried; (b) a method which comprises incorporating an acid or metal salt thereof into a homogeneous solution (water/alcohol solution, etc.) of the EVOH (A), extruding the mixture as a strand into a coagulating liquid, cutting the resultant strand into pellets, and then drying the pellets; (c) a method in which the EVOH (A) is mixed en bloc with an acid or metal salt thereof and the resultant mixture is melt-kneaded with an extruder or the like; and (d) a method in which the alkali (e.g., sodium hydroxide or potassium hydroxide) used in the saponification step in producing the EVOH (A) is neutralized with an acid such as, e.g., acetic acid and the amount of the residual acid, e.g., acetic acid, and the alkali metal salt generated as a by-product, e.g., sodium acetate or potassium acetate, are regulated by a water washing treatment. From the standpoint of more remarkably obtaining the effects of the invention, method (a), (b), or (d) is preferred, in which the acid or metal salt thereof shows excellent dispersibility.

In the case where various additives are added to the EVOH (A) by method (a), (b), or (d) described above, various drying methods can be employed. Examples thereof include: fluidization drying in which an EVOH (A) composition in substantially a pellet form is dried while being stirred and dispersed mechanically or with hot air; and stationary drying in which the EVOH (A) composition is dried without exerting any dynamic action such as stirring or dispersion thereon. Examples of dryers usable for the fluidization drying include a cylindrical grooved stirring dryer, tubular dryer, rotating dryer, fluidized-bed dryer, vibrating fluidized-bed dryer, and conical rotating dryer. Examples of dryers usable for the stationary drying include dryers of the type in which materials are kept stationary, such as a box type batch dryer, and material transport type dryers such as a band dryer, tunnel dryer, and vertical dryer. However, usable dryers should not be construed as being limited to these examples. It is also possible to employ a combination of fluidization drying and stationary drying.

As a heating gas for the drying treatment, use may be made of air or an inert gas (e.g., nitrogen gas, helium gas, or argon gas). The temperature of the heating gas is preferably 40-150° C. from the standpoints of productivity and the prevention of thermal deterioration of the EVOH. The time period of the drying treatment is generally preferably about from 15 minutes to 72 hours from the standpoints of productivity and the prevention of thermal deterioration, although it depends on the water content of the EVOH (A) composition and the rate of treatment thereof.

The drying treatment is conducted under the conditions described above. The EVOH (A) which has undergone the drying treatment has a water content of generally 0.001-5% by weight, preferably 0.01-2% by weight, especially preferably 0.1-1% by weight. In case where the water content thereof is too low, long-run spinnability tends to decrease. Conversely, too high water contents result in a possibility that foaming might occur during melt spinning.

The target EVOH (A) or composition thereof is thus obtained. This EVOH (A) may contain a slight amount of a monomer residue (e.g., 3,4-diol-1-butene, 3,4-diacyloxy-1-butene, 3-acyloxy-4-ol-1-butene, 4-acyloxy-3-ol-1-butene, 4,5-diol-1-pentene, 4,5-diacyloxy-1-pentene, 4,5-diol-3-methyl-1-pentene, 4,5-diol-3-methyl-1-pentene, 5,6-diol-1-hexene, 5,6-diacyloxy-1-hexene, or 4,5-diacyloxy-2-methyl-1-butene) or a product of saponification of a monomer (e.g., 3,4-diol-1-butene, 4,5-diol-1-pentene, 4,5-diol-3-methyl-1-pentene, 4,5-diol-3-methyl-1-pentene, or 5,6-diol-1-hexene) so long as the presence thereof does not defeat the object of the invention.

A blend of the EVOH containing structural unit (1) and an EVOH different from that is also preferred for use in the invention because it gives fibers having satisfactory stretchability and satisfactory strength after stretching. Examples of the other EVOH include one differing in structural unit, one differing in ethylene content, one differing in the degree of saponification, and one differing in molecular weight.

Examples of the EVOH differing in structural unit from the EVOH having structural unit (1) include an EVOH consisting only of ethylene structural units and vinyl alcohol structural units and a modified EVOH which is an EVOH having functional groups such as, e.g., 2-hydroxyethoxy groups as side chains.

In the case where one differing in ethylene content is used, the other structural units may be the same or different. However, the difference in ethylene content is generally 1% by mole or larger, preferably 2% by mole or larger, especially preferably 2-20% by mole. When the difference in ethylene content is too large, there are cases where stretchability might be poor. Processes for producing two or more different EVOHs (or a blend thereof) are not particularly limited. Examples thereof include: a method in which pastes of unsaponified EVAs are mixed together and then saponified; a method in which solutions each prepared by dissolving an EVOH which has been saponified in an alcohol or a water/alcohol mixed solvent are mixed together; and a method in which EVOHs each in a pellet or powder form are mixed together and then melt-kneaded.

The melt flow rate (MFR) (210° C.; load, 2,160 g) of the EVOH (A) or composition thereof thus obtained also is not particularly limited. However, the MFR thereof is generally 0.1-100 g/10 min, preferably 0.5-70 g/10 min, especially preferably 10-50 g/10 min. In case where the melt flow rate thereof is too low, this resin has a high viscosity during melt spinning, making it difficult to spin uniform fibers. In case where the melt flow rate thereof is too high, fiber strength tends to decrease.

The EVOH (A) or composition thereof thus obtained may be processed as it is into fibers. In the invention, however, this EVOH (A) may be used as a composition obtained by incorporating various additives into the polymer so long as this incorporation does not defeat the object of the invention. Examples of the additives include lubricants such as saturated aliphatic amides (e.g., stearamide), unsaturated fatty acid amides (e.g., oleamide), bis-fatty acid amides (e.g., ethylenebisstearamide), fatty acid metal salts (e.g., calcium stearate and magnesium stearate), and low-molecular polyolefins (e.g., low-molecular polyethylene and low-molecular polypropylene each having a molecular weight of about 500-10,000), inorganic salts (e.g., hydrotalcite), plasticizers (e.g., aliphatic polyhydric alcohols such as ethylene glycol, glycerol, and hexanediol), heat stabilizers, light stabilizers, antioxidants, ultraviolet absorbers, colorants, antistatic agents, surfactants, antibacterials, antiblocking agents, slip agents, fillers (e.g., inorganic fillers), and other resins (e.g., polyolefins and polyamides).

The EVOH (A) or composition thereof thus obtained is formed into a fiber, whereby the EVOH fiber of the invention is obtained. Methods for fiber formation are not particularly limited. Examples thereof include melt spinning, wet spinning, and dry spinning. Of these, melt spinning is preferred because a high spinning rate is attained and a split type fiber can be easily spun.

Methods for the melt spinning are not particularly limited. However, a known melt spinning machine may be used to melt-spin through a single nozzle or composite nozzle. The spinning is conducted at a temperature at which the EVOH (A) melts and does not alter. The EVOH (A) may be extruded at a spinning temperature of 200-320° C. to produce a spun filament having a given fineness.

Although the EVOH (A) may be spun into a single-component fiber, it is preferred that the EVOH (A) should be spun together with another thermoplastic resin (B) to obtain a composite fiber in order to impart satisfactory strength and flexibility to the nonwoven fabric to be obtained therefrom. The term composite fiber in the invention means a single fiber in which two or more resins differing in component are present as respective two or more phases. The composite fiber may be either a monofilament or a multifilament.

Examples of the form of the composite fiber include a core/sheath type composite fiber, eccentric core/sheath type composite fiber, side-by-side type composite fiber, split type composite fiber, and sea-island type composite fiber. The cross-sectional shape thereof is not particularly limited, and may be, for example, not only a circular or elliptic shape but also any of other various shapes such as hollow, triangular, quadrangular, rhombic, star, and flat shapes.

In the case of the core/sheath type, the fiber may be either one in which the sheath part is ingredient (A) and the core part is ingredient (B) or one in which the sheath part is ingredient (B) and the core part is ingredient (A). Preferably, however, the fiber is one in which the sheath part is ingredient (A) and the core part is ingredient (B).

In the case of the split type, the fiber may be either one in which ingredient (B) has been separated into segments by ingredient (A) or one in which ingredient (A) has been separated into segments by ingredient (B). Preferably, however, the fiber is one in which ingredient (A) has been separated into segments by ingredient (B). The shape into which one ingredient has been separated may be a known one. In general, however, one ingredient has been separated radially into an even number of segments, preferably separated radially into 4-8 segments.

Of those, the split type composite fiber is preferred because it brings about satisfactory liquid retentivity.

The thermoplastic resin (B) to be combined is not particularly limited. One or more members selected at will from homopolymers, copolymers, and terpolymers, such as polyester polymers, e.g., poly(ethylene terephthalate) and poly(butylene terephthalate), polyamide polymers, e.g., nylon-6 and nylon-6,6, and polyolefin polymers, e.g., polypropylene and polymethylpentene, can be used as the resin (B).

The ratio (volume ratio) in which the EVOH (A) is combined with the thermoplastic resin (B), a resin other than the EVOH composition, is generally from 10/90 to 90/10, preferably from 25/75 to 75/25, especially preferably from 35/65 to 65/35. Too low combination ratios of the EVOH (A) tend to result in a battery separator having insufficient liquid retentivity. Conversely, too high ratios thereof tend to result in a nonwoven fabric having insufficient strength.

The spun filament obtained is stretched according to need. Treatment at a stretching temperature of 20-90° C. in a stretch ratio of 2 or higher is preferred because it improves fiber strength. According to need, the filament may be crimped with a crimper and cut into a given length. Thus, the EVOH fiber of the invention is obtained.

The fiber diameter of the EVOH fiber is not particularly limited, and a preferred fiber diameter is selected according to the application of the fiber. However, the diameter thereof is generally 0.1-100 deniers. Especially in battery separators, the diameter of the fiber is generally 0.5-50 deniers, especially preferably 1-30 deniers, from the standpoints of electrolyte retentivity and the prevention of movement of electrode active materials. Fiber length also is not particularly limited. However, in the case of forming a nonwoven fabric by a wet process, the length of the fiber is preferably about 1-70 mm.

Methods for forming a nonwoven fabric from the EVOH fiber obtained are not particularly limited. With respect to the form of nonwoven fabric, a dry web obtained by the carding method, air laying method, or the like, a wet web obtained by a wet process, or a fibrous web obtained by a direct process such as the melt blowing method or spunbonding method is subjected, either alone or as a multilayer assembly composed of two or more layers including the web as at least one layer, to processing by a mechanical entangling treatment by the needle punching method or spunlacing method, a heat-bonding treatment such as the hot-roll method, hot-air bonding method, or ultrasonic bonding method, or a combination of these to thereby produce a nonwoven fabric.

Subsequently, the fibrous mass is united together by a mechanical entangling treatment by the needle punching method or spunlacing method, a heat-bonding treatment such as the hot-roll method, hot-air bonding method, or ultrasonic bonding method, or a combination of these. For example, the fibrous web is preferably subjected to a spunlacing treatment to split the split type fiber to form microfibers having a fineness of 0.5 deniers or less and simultaneously entangle the fibers.

The basis weight and apparent density of the nonwoven fabric thus obtained are not particularly limited. In general, however, the basis weight thereof is 10-10 g/m² and the apparent density thereof is 0.01-10 g/cm³. Especially in the case of battery separators, it is preferred to use one having a basis weight of 30-70 g/m² and an apparent density of 0.1-1 g/cm³. Incidentally, the tensile strength in one direction of this nonwoven fabric is preferably 30 N/5 cm or higher. Especially in battery separators, the tensile strength of the nonwoven fabric is preferably 50 N/5 cm or higher. Too low tensile strengths thereof are undesirable because such a nonwoven fabric has poor suitability for winding in battery fabrication.

### EXAMPLES

The invention will be explained below by reference to Examples, but the invention should not be construed as being limited to the Examples only.

Hereinafter, “%” and “parts” are by weight unless otherwise indicated.

### Production Example 1

### EVOH (A1)

Into a 1-m³ polymerization reactor having a cooling coil were introduced 500 kg of vinyl acetate, 100 kg of methanol, 500 ppm acetyl peroxide (based on the vinyl acetate), 20 ppm citric acid (based on the vinyl acetate), and 14 kg of 3,4-diacetoxy-1-butene. The atmosphere in the system was once replaced by nitrogen gas and then replaced by ethylene. Ethylene was forced into the polymerization reactor to an ethylene pressure of 35 kg/cm². The contents were heated to 67° C. with stirring to initiate polymerization. Thereafter, 4.5 kg of 3,4-diacetoxy-1-butene was added at a rate of 15 g/min, and the monomers were polymerized for 6 hours until the conversion into polymer reached 50%. Thus, a methanol solution of an ethylene/vinyl acetate copolymer having an ethylene content of 29% by mole was obtained.

The resultant methanol solution of the ethylene/vinyl acetate copolymer was fed at a rate of 10 kg/hr to a top part of a plate column (saponification column). Simultaneously therewith, a methanol solution containing sodium hydroxide in an amount of 0.012 equivalents to the residual acetic acid groups in the copolymer was supplied to the top part of the column. On the other hand, methanol was supplied to a bottom part of the column at a rate of 15 kg/hr. The temperature in the column was 100-110° C., and the column pressure was 3 kg/cm²G. At 30 minutes after initiation of the feeding, a methanol solution of an EVOH (A1) containing structural unit (1) (EVOH (A1), 30%; methanol, 70%) began to be discharged. This EVOH (A1) had a degree of saponification of 99.5% by mole.

Subsequently, the EVOH (A1) solution in methanol was fed at a rate of 10 kg/hr to a top part of a methanol/water solution preparation column. Methanol vapor having a temperature of 120° C. and water vapor were supplied to a lower part of the column at rates of 4 kg/hr and 2.5 kg/hr, respectively, and methanol was distilled off through the column top at a rate of 8 kg/hr. Simultaneously therewith, methyl acetate was supplied to a middle part of the column having an internal temperature of 95-110° C. in an amount of 6 equivalents to the sodium hydroxide used for the saponification. A water/alcohol solution of the EVOH (A1) (resin concentration, 35%) was obtained through the column bottom.

The resultant water/alcohol solution of the EVOH (A1) was extruded as a strand from a nozzle having an opening diameter of 4 mm into a tank of a coagulating liquid kept at 5° C. composed of 5% methanol and 95% water. After completion of the coagulation, the strand was cut with a cutter to obtain porous pellets of the EVOH (A1) having a diameter of 3.8 mm, length of 4 mm, and water content of 45%.

The ethylene/vinyl acetate copolymer which had not been saponified was examined by ¹H-NMR spectroscopy (internal reference, tetramethylsilane; solvent, d6-DMSO) to calculate the content of structural unit (1) in the EVOH (A1) obtained. As a result, the content thereof was found to be 2.5% by mole. For the NMR spectroscopy, use was made of “AVANCE DPX400” manufactured by Bruker Japan Co., Ltd.

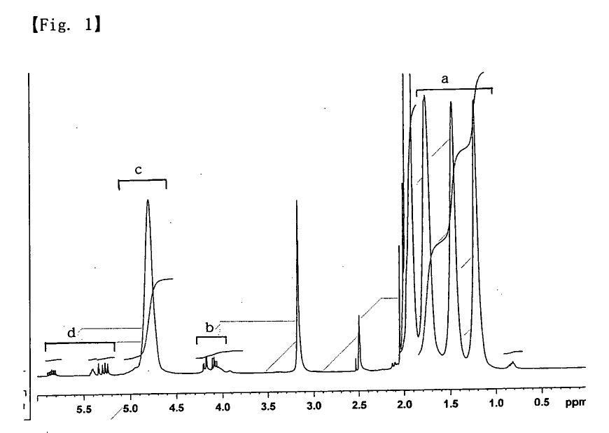

The structure of the ethylene/vinyl acetate copolymer having structural unit (1) is shown by the following chemical formula (6).

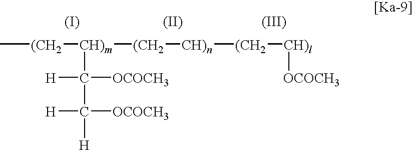

[In chemical formula (6), (I) is one or more units derived from one or more structural units (1); (II) is one or more units derived from ethylene; (III) is one or more units derived from vinyl acetate; and m, n, and 1 each independently represent an integer of 1 or larger.]

[¹H-NMR] (Chemical Formula (6); see FIG. 1)
1.0-1.8 ppm: methylene protons (integral a in FIG. 1)
1.87-2.06 ppm: methyl protons
3.95-4.3 ppm: methylene-side protons in structure (I)+protons of unreacted 3,4-diacetoxy-1-butene (integral b in FIG. 1)
4.6-5.1 ppm: methine proton+methine-side proton of structure (I) (integral c in FIG. 1)
5.2-5.9 ppm: protons of unreacted 3,4-diacetoxy-1-butene (integral d in FIG. 1)

### [Method of Calculating Content of Structural Units (1)]

Since four protons are present at 5.2-5.9 ppm, the integral for one proton is d/4. Integral b is an integral value for the protons of both the diol and the monomer. The integral (A) for one proton of the diol is hence represented by A=(b−d/2)/2. Integral c is an integral value for the protons of both vinyl acetate and the diol. The integral (B) for one proton of vinyl acetate is hence represented by B=1−(b−d/2)/2. Integral “a” is an integral value for both ethylene and methylene. The integral (C) for one proton of ethylene is hence represented by C=(a−2×A−2×B)/4=(a−2)/4. Based on these calculations, the content of structural unit (1) was calculated using 100×{A/(A+B+C)}=100×(2×b−d)/(a+2).

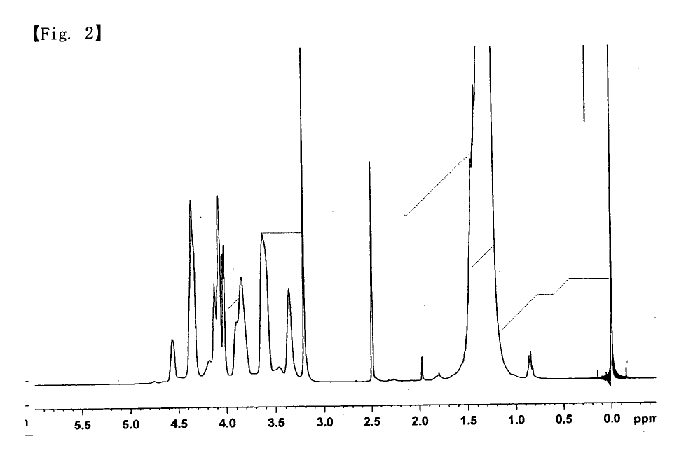

The EVOH which had been saponified was subjected to ¹H-NMR spectroscopy in the same manner. The results obtained are shown in FIG. 2. The peak at 1.87-2.06 ppm attributable to methyl protons diminished considerably. It is therefore apparent that the 3,4-diacetoxy-1-butene copolymerized had also been saponified and come to have a 1,2-glycol structure.

Subsequently, the EVOH (A1) pellets obtained were washed with 100 parts of water per 100 parts of the pellets and then introduced into a mixture solution containing 0.032% boric acid and 0.007% calcium dihydrogen phosphate. The resultant mixture was stirred at 30° C. for 5 hours. Thereafter, the pellets were dried with a box type through-flow batch dryer for 12 hours while passing nitrogen gas having a temperature of 70° C. and a water content of 0.6% therethrough. The water content of the pellets was thus regulated to 30%. Furthermore, a column type fluidized-bed batch dryer was used to dry the pellets for 12 hours with nitrogen gas having a temperature of 120° C. and a water content of 0.5%. Thus, EVOH (A1) composition pellets were obtained as the target product.

The resultant EVOH (A1) composition pellets contained 0.015 parts by weight of boric acid (in terms of boron amount) and 0.005 parts by weight of calcium dihydrogen phosphate (in terms of phosphoric acid radical amount) per 100 parts by weight of the EVOH (A1). This EVOH (A1) composition had an MFR of 4.0 g/10 min (210° C., 2,160 g).

### Production Example 2

### EVOH (A2)

The same procedure as in Production Example 1 was conducted, except that a 70/20/10 (by weight) mixture of 3,4-diacetoxy-1-butene, 3-acetoxy-4-ol-1-butene, and 1,4-diacetoxy-1-butene was used in place of the 3,4-diacetoxy-1-butene. Thus, an EVOH (A2) having an ethylene content of 29% by mole, degree of saponification of 99.5% by mole, and content of structural unit (1) of 2.0% by mole was obtained.

Furthermore, the same treatment as in Production Example 1 was conducted. Thus, EVOH (A2) composition pellets were obtained which had a boric acid content of 0.015 parts by weight (in terms of boron amount) and a calcium dihydrogen phosphate content of 0.005 parts by weight (in terms of phosphoric acid radical amount) per 100 parts by weight of the EVOH (A2).

This EVOH (A2) composition had an MFR of 3.7 g/10 min (210° C., 2,160 g).

### Production Example 3

### Unmodified EVOH

An unmodified EVOH containing no structural unit (1) (ethylene content, 29% by mole; degree of saponification, 99.5% by mole) was subjected to the same treatment as in Production Example 1. Thus, an unmodified EVOH composition was obtained which had a boric acid content of 0.015 parts by weight (in terms of boron amount) and a calcium dihydrogen phosphate content of 0.005 parts by weight per 100 parts by weight of the EVOH.

This unmodified EVOH composition had an MFR of 3.2 g/10 min (210, 2,160 g).

### Example 1

The EVOH (A1) composition pellets obtained in Production Example 1 and polypropylene having an MFR of 11 g/10 min (JIS K7210) (“Novatec PP SA3A” manufactured by Japan Polypropylene Corp.) were used and melt-spun at a spinning temperature of 260° C. and a spinning rate of 600 m/min to obtain an unstretched filament having a fineness of 5 deniers. This filament had a combination ratio of 50/50 and had a fiber section in which the two components had been radially separated into eight. This filament was stretched in a stretch ratio of 3 at a stretching temperature of 100° C. to obtain a composite fiber having a fineness of 1.7 deniers which was of the type split into eight.

The composite fiber obtained was cut into a fiber length of 10 mm and dispersed in water to prepare a slurry having a concentration of 0.5%. The slurry was formed into a raw sheet having a basis weight of 50 g/m² by the wet papermaking method, and the fibers were entangled by the spunlacing method to obtain a nonwoven fabric.

The nonwoven fabric obtained was evaluated for the following properties.

### [Liquid Absorption]

A nonwoven-fabric test piece having dimensions of 5 cm×5 cm was examined for weight (W₀) and immersed in a 30° C. saturated aqueous solution of potassium hydroxide for 15 minutes. Thereafter, the test piece was placed on a horizontal plate. A load of 5 kg was imposed thereon and the test piece in this state was allowed to stand for 30 minutes. Thereafter, the weight (W₁) of this test piece was measured and the liquid absorption thereof was determined using the following equation (7).

Liquid absorption(%)=(W₁−W₀)/W₀×100 (7)

### [Oxidation Resistance]

A nonwoven-fabric test piece having dimensions of 5 cm×5 cm was sufficiently dried, and the weight (W₂) thereof was then measured. This test piece was immersed in a 30% aqueous solution of concentrated sulfuric acid at 60° C. for 24 hr. Thereafter, the test piece was washed well, subsequently sufficiently dried, and then examined for weight (W₃). The resultant weight change was determined using the following equation (8). The smaller the weight change through the treatment with concentrated sulfuric acid, the higher the evaluation of acid resistance.

Weight change(%)=(W₂−W₃)/W₂×100 (8)

### Example 2

A nonwoven fabric was obtained in the same manner as in Example 1, except that the EVOH composition (A2) was used in place of the EVOH composition (A1). The nonwoven fabric obtained was evaluated in the same manner.

### Comparative Example 1

A nonwoven fabric was obtained in the same manner as in Example 1, except that the unmodified EVOH composition was used in place of the EVOH composition (A1). The nonwoven fabric obtained was evaluated in the same manner.

The evaluation results obtained in the Examples and Comparative Example are summarized in Table 1.

TABLE 1

| | Liquid absorption (%) | Oxidation resistance (%) |
|---|---|---|
| Example 1 | 270 | 0.3 |
| Example 2 | 260 | 0.4 |
| Comparative | 220 | 1.5 |
| Example 1 | | |

The results given above show that the nonwoven fabrics of the invention have a higher electrolyte absorption than the nonwoven fabric made of an EVOH fiber having no structural unit (1) shown above. Because of this, when these nonwoven fabric are used as a battery separator, the battery can undergo sufficient electromotive reactions. It was likewise demonstrated that the nonwoven fabrics of the invention have a small weight change through the acid treatment and are hence characterized by being less apt to cause battery deterioration.

Those effects of the invention are produced because the EVOH (A) having structural unit (1) shown above is contained.

While the invention has been described in detail and with reference to specific embodiments thereof, it will be apparent to one skilled in the art that various changes and modifications can be made therein without departing from the spirit and scope thereof.

This application is based on a Japanese patent application filed on Nov. 14, 2005 (Application No. 2005-329114), the contents thereof being herein incorporated by reference.

### INDUSTRIAL APPLICABILITY

The invention provides an EVOH fiber which is excellent in electrolyte absorption/retentivity and oxidation resistance and is suitable for use as a separator for alkaline secondary batteries.

1. An ethylene/vinyl alcohol-derived copolymer fiber comprising an ethylene/vinyl alcohol-derived copolymer (A) having the following structural unit (1); 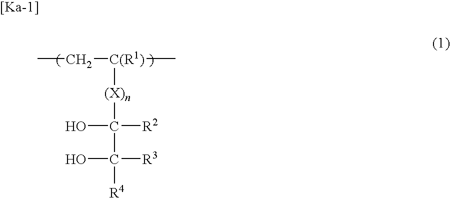
(wherein R¹ represents a hydrogen atom or an organic group; X represents a bonding chain other than ether bond; n represents 0 or 1; and R² to R⁴ each represent a hydrogen atom or an organic group).

2. The ethylene/vinyl alcohol-derived copolymer fiber according to claim 1, wherein in the structural unit (1), R¹ is a hydrogen atom, n is 0, and R² to R⁴ each are a hydrogen atom.

3. The ethylene/vinyl alcohol-derived copolymer fiber according to claim 1, wherein the content of structural unit (1) in the ethylene/vinyl alcohol-derived copolymer (A) is 0.1-30% by mole.

4. The ethylene/vinyl alcohol-derived copolymer fiber according to claim 1, wherein the ethylene/vinyl alcohol-derived copolymer (A) has an ethylene content of 10-60% by mole.

5. The ethylene/vinyl alcohol-derived copolymer fiber according to claim 1, wherein the ethylene/vinyl alcohol-derived copolymer (A) is one obtained by saponifying a copolymer of a 3,4-diacyloxy-1-butene, a vinyl ester monomer, and ethylene.

6. The ethylene/vinyl alcohol-derived copolymer fiber according to claim 1, wherein the ethylene/vinyl alcohol-derived copolymer (A) is a composition containing a boron compound.

7. The ethylene/vinyl alcohol-derived copolymer fiber according to claim 1, wherein the ethylene/vinyl alcohol-derived copolymer (A) is a composition containing a phosphoric acid compound.

8. The ethylene/vinyl alcohol-derived copolymer fiber according to claim 7, wherein the phosphoric acid compound is a phosphoric acid salt.

9. An ethylene/vinyl alcohol-derived copolymer fiber, which is a composite fiber comprising an ethylene/vinyl alcohol-derived copolymer (A) having the following structural unit (1) and a thermoplastic resin (B) other than the (A): 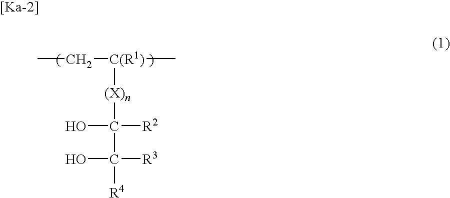
(wherein R¹ represents a hydrogen atom or an organic group; X represents a bonding chain other than ether bond; n represents 0 or 1; and R² to R⁴ each represent a hydrogen atom or an organic group).

10. The ethylene/vinyl alcohol-derived copolymer fiber according to claim 9, wherein the composite fiber is a split type composite fiber.

11. The ethylene/vinyl alcohol-derived copolymer fiber according to claim 9, wherein the composite fiber is a core/sheath type composite fiber.

12. The ethylene/vinyl alcohol-derived copolymer fiber according to claim 9, wherein the thermoplastic resin (B) is any of a polyester polymer, a polyamide polymer, and a polyolefin polymer.

13. The ethylene/vinyl alcohol-derived copolymer fiber according to claim 9, wherein the ratio in which the ethylene/vinyl alcohol-derived copolymer (A) and the thermoplastic resin (B) are combined is from 10/90 to 90/10.

14. The ethylene/vinyl alcohol-derived copolymer fiber according to claim 1, which has a fiber diameter of 0.1-100 deniers.

15. A nonwoven fabric comprising the ethylene/vinyl alcohol-derived copolymer fiber according to claim 1.

16. The nonwoven fabric according to claim 15, which has a basis weight of 10-100 g/m².

17. A separator for batteries, comprising the nonwoven fabric according to claim 15.

18. The ethylene/vinyl alcohol-derived copolymer fiber according to claim 9, which has a fiber diameter of 0.1-100 deniers.

19. A nonwoven fabric comprising the ethylene/vinyl alcohol-derived copolymer fiber according to claim 9.

20. The nonwoven fabric according to claim 19, which has a basis weight of 10-100 g/m²
